(19) United States
(12) Patent Application Publication
(10) Pub. No.: US 2009/0269124 A1
(43) Pub. Date: Oct. 29, 2009

(54) FLUID DISPENSER FOR FLOORS

(76) Inventor: MARK RADDICK, Dunnville (CA)

Correspondence Address: Mark A. Koch;Professional Corporation, 583 Main Street East, Hamilton, ON, L8M 1J4, CA

(21) Appl. No.: 12/426,328

(22) Filed: Apr. 20, 2009

Related U.S. Application Data
(60) Provisional application No. 61/048,250, filed on Apr. 28, 2008.

(51) Int. Cl. A46B 11/00; B67D 5/00

(52) U.S. Cl. 401/268; 222/608

(57) ABSTRACT

The fluid dispenser for application of solutions applied to floors, includes a frame for supporting a container, the frame includes at least three legs supported by wheels mounted on a bottom end of each leg such that the frame can roll along the surface of a floor. The container is for holding solutions. A mop assembly is for fluidly communicating by gravity feed, the solution from the container to the mop head and bristles and for manually manipulating the mop head. The dispenser further includes a harness attached to the frame for securely attaching the fluid dispenser to the back side of a person such that the frame is always positioned behind the person.

This application claims priority from previously regularly file U.S. provisional application 61/048,250 filed on Apr. 28, 2008 under the title Fluid Dispenser For Floors by Mark Raddick.

### FIELD OF THE INVENTION

The present invention relates to devices for dispensing fluids onto floors, in particular relates to a fluid dispenser for floors which is always positioned behind the person using the fluid dispenser. The fluid dispenser for application of solutions applied to floors, includes a frame for supporting a container, the frame includes at least three legs supported by wheels mounted on a bottom end of each leg such that the frame can roll along the surface of a floor. The container is for holding solutions. A mop assembly is for fluidly communicating by gravity feed, the solution from the container to the mop head and bristles and for manually manipulating the mop head. The dispenser further includes a harness attached to the frame for securely attaching the fluid dispenser to the back side of a person such that the frame is always positioned behind the person.

### BRIEF DESCRIPTION OF THE DRAWINGS

The device will now be described by way of example only with reference to the following drawings:

FIG. 1 is a top plan view of the fluid dispenser.

FIG. 2 is a left side elevational view of the fluid dispenser.

FIG. 3 is a top plan view of the fluid dispenser rotated 90 degrees relative to FIG. 1.

FIG. 4 is a front side elevational view showing the harness features.

FIG. 5 is a top schematic perspective view of the fluid dispenser.

FIG. 6 is a top schematic perspective view of the fluid dispenser deployed onto a person shown in dashed lines.

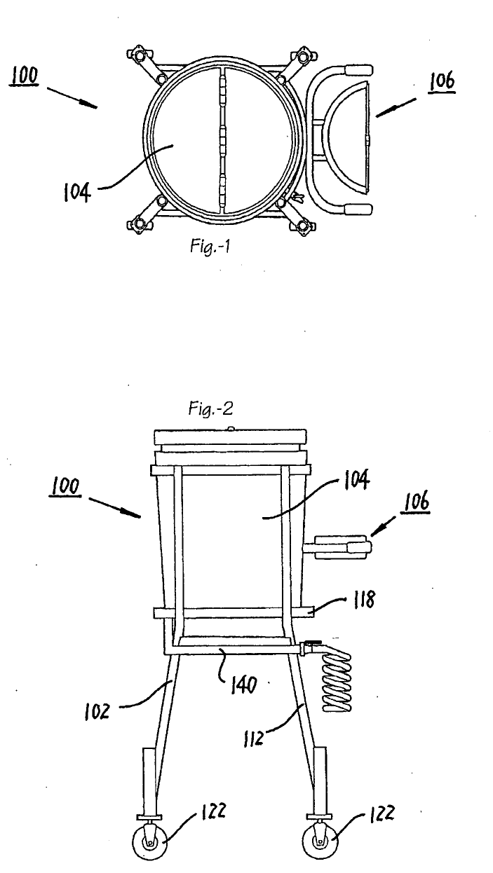

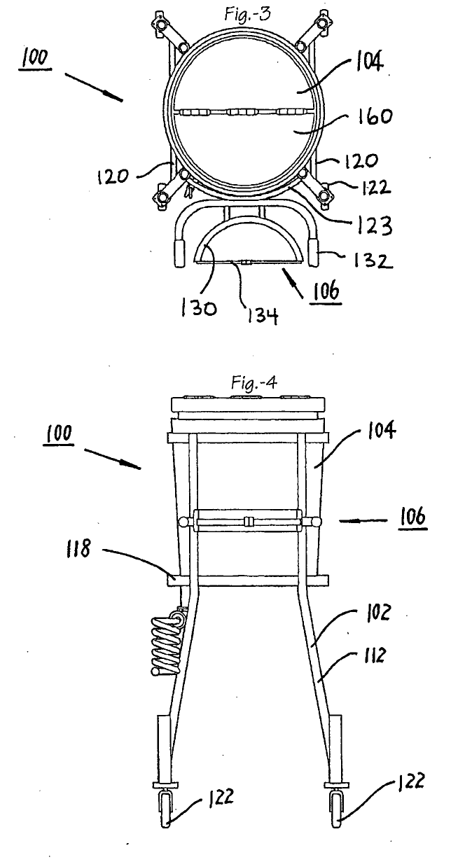

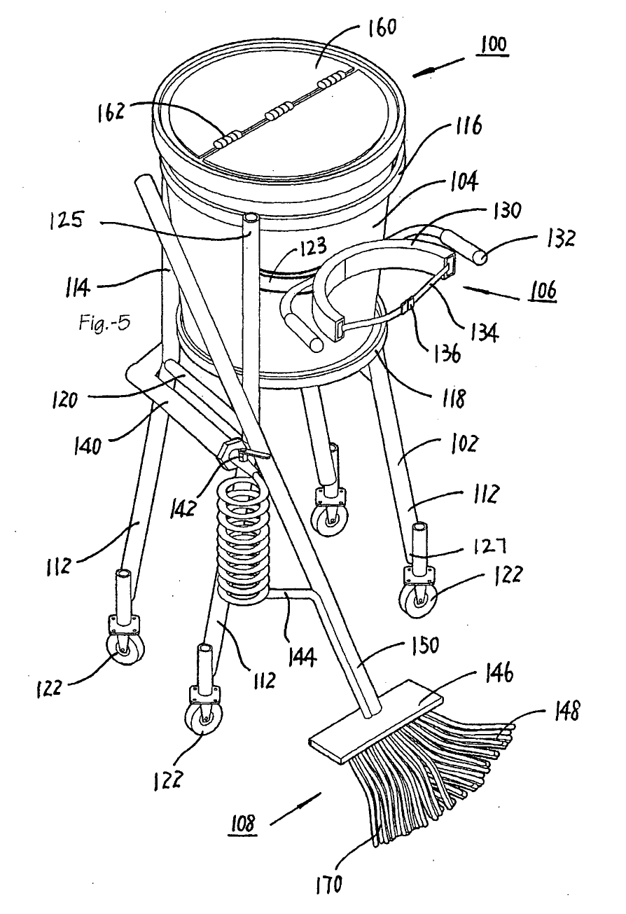

### DETAILED DESCRIPTION OF THE PREFERRED EMBODIMENT

The present device the fluid dispenser shown generally as 100 includes the following major components, namely frame 102, container 104, harness 106 and mop assembly 108.

Frame 102 includes the following components, legs 112 having a top end 125 and bottom end 127, struts 114, upper cage 116, platform 118, cross members 120, and harness bracket 123.

The frame is adapted to move rollably along the surface of a floor by attaching wheels 122 to each bottom end 127 of each leg 112. The wheels can of any type known in the art with one example only depicted in the drawings.

Kindly note in the drawings the frame 102 is shown with four legs 112, however there could be as few as three and there could be any other number larger than three used to support the entire fluid dispenser 100.

The upper portion of each leg 112 becomes a strut 114 which terminates at upper cage 116. Platform 118 is dimensioned to hold container 104 thereon and upper cage 116 is designed to maintain container 140 within the frame 102. The upper cage 116 preferably being a circular ring dimensioned to fit around the outer diameter of a preferably circular container 104, The container and upper cage 116 and container 104 may also be another shape such as square for example.

Harness 106 includes a U-bracket 130, handles 132, a strap 134 and a clip 136. Clip 136 can be any adjustable variety known in the art such as for example but not limited to a cam buckle, or belt buckle, or slip buckle, or snap buckle adapted to adjust to a variety of different sized persons.

Mop assembly 108 includes an outlet pipe 140 which is fluidly connected to container 104. Outlet pipe 140 terminates at a valve 142 which is fluidly connected to a hose 144 which in turn is fluidly connected to a mop head 146 and ultimately fluid is dispensed and distributed into mop head 146 and further into bristles 170. Mop assembly 108 further includes a mop handle 150 for attachment to the mop head 146. Fluid is dispensed from container 104 and communicated to mop head 146 and bristles 170.

The mop assembly 108 fluidly communicates the solution from container 104 by gravity feed to the mop head 146 and bristles 170 and is also used for manually manipulating the mop head 146 via mop handle 150. Container 104 optionally includes a lid 160 which includes hinges 162 for pivotally opening and closing a portion of the lid 160.

Mop head 146 and mop 148 may be of various designs including, long bristled type mop, or a short bristled type mop and/or more of scrub pad type mop. The harness includes at least one handle 132 rigidly connected to the frame. Preferably there are two handles 132 projecting forwardly on either side of the person for grasping in the hand and directing the movement of the fluid dispenser by urging either handle 132 in a selected direction of travel.

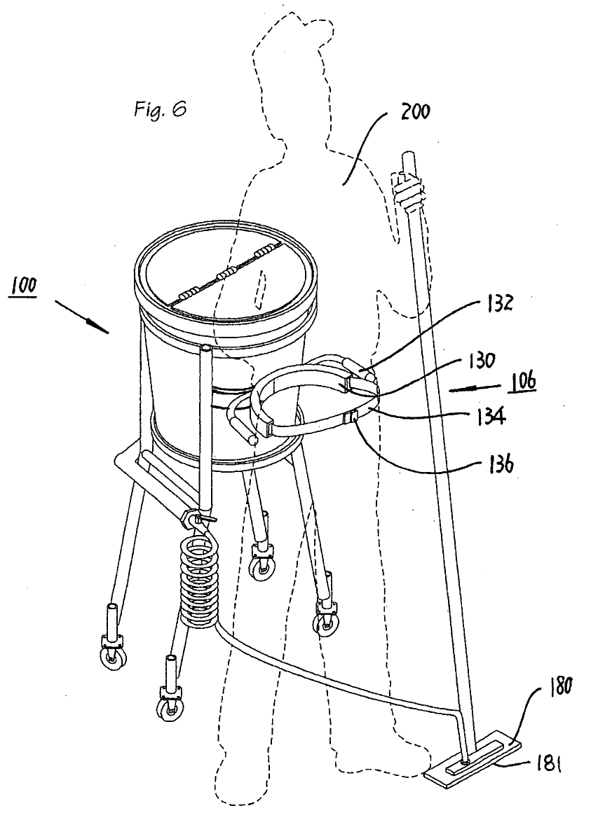

In FIG. 5 for example, mop 148 is shown having long traditional bristles 170 along with mope head 146. In FIG. 6 for example, mop head 180 is shown having no bristles but rather is simply a scrub pad 181 on the bottom of mop head 180 thereon not shown in the view.

Referring now to FIG. 6 a person 200 is shown in dashed lines being fastened into a harness 106, wherein the buttocks or back side of a person is fastened to U-bracket 130 with a strap 134 which is brought around the hips or front side of person 200 and the ends fastened together using clip 136 together thereby holding person 200 securely to fluid dispenser 100. In this manner the frame 102 of fluid dispenser 100 is always positioned behind the person. Person 200 can use one of the handles 132 for directing the movement of fluid dispenser 100. The back side of a person may include for example the buttocks or lower back or lower back torso depending upon comfort and personal preference.

In use fluid dispenser is used as shown in the Figures. The product and/or fluid that one wishes to apply to a floor for example is poured into container 104 through open lid 160. Lid 160 is then optionally closed to prevent splashing of the contents.

The operator of fluid dispenser 100 would strap himself onto fluid dispenser 100 by placing ones buttocks onto U-bracket 130 and fastening strap 134 with clip 136 around the persons hips. U-bracket 130 is U shaped to fit the contour of the backside of a person.

Product and/or fluid which is applied to the floor is fluidly communicated through outlet pipe 140 which is controlled by adjusting valve 142 to the desired flow rate. Fluid flows down through hose 144 and ultimately down to mop head 146 and/or mop head 180 and onto bristles 170 or scrub pad 181. Valve 142 may be any type known in the art for controlling fluid flow including for example but not limited to a butterfly valve, or ball and cock valve, or plunger and seat valve, or slide gate valve. It may be a manual valve or remotely operated valve.

Person 200 is able to control the flow of fluid from container 104 down to mop head 146 by adjusting manually valve 142 until the desired flow is obtained. The fluid is gravity fed down to the mop head 146.

The reader will note that there is no necessity for pumps or any other type of devices to get fluid down to mop head 146 since the container 104 is elevated above the floor level.

The reader will also note that the fluid dispenser 100 is always positioned behind person 200, therefore it would not get in the way of the person handling the mop assembly 108.

The container 104 of fluid dispenser 100 could be filled with any suitable solutions and could for example be used for applying floor stripper, could be used for applying floor waxes, could be used for applying floor polishes, floor cleaners and/or any other products that are applied to a floors.

One benefit of using fluid dispenser 100 other than the obvious benefits that one can see from the design is that the fluid dispensing unit is always out of the way and always in the correct position relative to the person 200 since it is securely fastened to the back side of a person 200.

This is an important feature when floors become very slippery with the application fluids and/or products to the floor. Should the person 200 loose his footing, he would be supported by fluid dispenser 100 through the harness 106, thereby preventing serious fall.

Fluid dispenser 100 is designed in such a manner that it would support the weight of a person through harness 106 and would not be easily tipped over when the weight of a person is applied to harness 106.

As indicated above many mop designs or bristles can be used in association with fluid dispenser 100 namely, the traditional long bristle and/or short bristle and/or thin scrub pad 181. The term bristle is used for any of these types. The mop head 146 is fluidly connected to the hose 144 and is designed to receive the solution and disperse it evenly onto the bristles depicted as 170 or 181.

It should be apparent to persons skilled in the arts that various modifications and adaptation of this structure described above are possible without departure from the spirit of the invention the scope of which defined in the appended claim.

I claim:

1) A fluid dispenser for application of solutions applied to floors, the fluid dispenser comprising:
a) a frame for supporting a container, the frame includes at least three legs supported by wheels mounted on a bottom end of each leg such that the frame can roll along the surface of a floor;
b) the container for holding solutions;
c) a mop assembly for fluidly communicating by gravity feed, the solution from the container to the mop head and bristles and for manually manipulating the mop head;
d) a harness attached to the frame for securely attaching the fluid dispenser to the back side of a person such that the frame is always positioned behind the person.

2) The fluid dispenser claimed in claim 1 wherein the harness includes a U shaped bracket rigidly attached to the frame and adapted to contact the back side of the person.

3) The fluid dispenser claimed in claim 2 wherein the harness includes straps attached at to each distal end of the U shaped bracket and extending around to the front side of a person for securing the U shaped bracket to the back side of the person.

4) The fluid dispenser claimed in claim 3 wherein the harness includes an adjustable clip for releasably securing the harness to the back side of the person.

5) The fluid dispenser claimed in claim 2 wherein the harness includes at least one handle rigidly connected to the frame and projecting forwardly for grasping in the hand and directing the movement of the fluid dispenser by urging the handle in a selected direction of travel.

6) The fluid dispenser claimed in claim 5 wherein there are two handles projecting forwardly on either side of the person for grasping in the hand and directing the movement of the fluid dispenser by urging either handle in a selected direction of travel.

7) The fluid dispenser claimed in claim 1 wherein the mop assembly further includes an outlet pipe fluidly connected at one to the container and at the other end to a hose, the outlet pipe including a valve for selecting the amount of flow of solution.

8) The fluid dispenser claimed in claim 7 wherein the mop assembly further includes a mop head fluidly connected to the hose for receiving solution and dispersing it evenly onto a bristle.

9) The fluid dispenser claimed in claim 8 wherein the mop assembly further including a mop handle for manually manipulating the mop head.

10) The fluid dispenser claimed in claim 9 wherein the frame includes a platform connected to the frame for supporting the container at a height above the floor.

11) The fluid dispenser claimed in claim 10 wherein the frame further includes an upper cage connected to the frame and spaced from and above the platform for supporting the container.

12) The fluid dispenser claimed in claim 11 wherein the upper cage being a circular ring dimensioned to fit around the outer diameter of a circular container.

13) The fluid dispenser claimed in claim 4 wherein the frame and harness are capable of supporting the weight of the fluid dispenser and a person.
